(19) United States
(12) Patent Application Publication
(10) Pub. No.: US 2014/0067517 A1
(43) Pub. Date: Mar. 6, 2014

(54) Interactive Real-Time Marketing Systems, Their Methods of Production and Use

(71) Applicants: Rob Volpe, San Francisco, CA (US); Matt Sorlien, Palo Alto, CA (US)

(72) Inventors: Rob Volpe, San Francisco, CA (US); Matt Sorlien, Palo Alto, CA (US)

(21) Appl. No.: 13/599,917

(22) Filed: Aug. 30, 2012

(51) Int. Cl. G06Q 30/02

(52) U.S. Cl. CPC G06Q 30/0241
USPC 705/14.41; 705/14.4

(57) ABSTRACT

Interactive and active information executable applications comprise: a) at least one marketing campaign item, b) at least one piece of insight information, c) at least one dynamic consumer profile, d) at least one metric bank, and e) at least one storage medium. Methods for implementing and utilizing an interactive and active information executable application include: providing at least one marketing campaign item, providing or collecting at least one piece of insight information, providing at least one metric bank, storing the at least one piece of insight information on the at least one metric bank, utilizing or accessing at least one metric bank, developing at least one dynamic consumer profile from the at least one piece of insight information, and accessing at least one computer readable storage medium.

### FIELD OF THE SUBJECT MATTER

The field of the subject matter is interactive, real-time marketing systems, their methods of production and use.

### BACKGROUND

Marketing teams often struggle with new campaigns for a company's products and/or services in a number of different ways. The first is getting all of the decision makers together and engaged in the process, so that they can make an informed decision on the campaign. The second is developing options for the campaign and being able to roll out new options on the fly as information is received during the campaign roll out. The third is tracking useful metrics related to the campaign and its impact. Finally, the marketing team and the company must be able to make sense of the metrics in real time to determine if the campaign is on point or whether other marketing options should be presented.

Marketing teams and their clients look for several things in a marketing campaign: a) it must reach people, b) it must drive consumers to purchase products and/or services, and c) there should be a way of capturing information as to the success of the campaign. In the past, the success of a marketing campaign would be captured by the increase in sales in a product or service. In some instances, the “buzz” generated around an advertising campaign could be loosely captured.

The rise of the internet and of social media directly benefits marketing teams and companies in that the ability to quantify the success of a marketing campaign increases. From “shares” and “likes” on Facebook, to “retweets” on Twitter.com, to click throughs on banner ads and links and comments on youtube.com—marketing teams are finding new ways to quantify the impact of a marketing campaign, new product, new service or a combination thereof on the general public.

Conventional metrics and systems do not provide a real-time mechanism for providing marketing information to the company that is comprehensive and related to a particular product, service or campaign. Previously, this information was stored on printed hard copies and carried around or left behind at the user's desk. Electronic versions were stored on laptops and also were rarely referenced as they had to be found on the user's computer or server, opened and then reviewed to find the relevant information.

Therefore, there is a need in the industry for a system that can allow marketing teams to push out proposed campaign content, along with historical and analyzed data and/or any other helpful information, to key decision makers for review, approval and comment, display the current campaign in all of its forms, capture and present interactive real time marketing data for a company, and at the same time allow the marketing professionals and marketing field teams access to the same information in order to track dynamic consumer interaction with the campaign, product or service. There is also a need for a system or service that can build a typical consumer profile that is in real time and dynamic. Finally, there is a need to be able to access all of this information through the use of an executable mobile application or app.

### SUMMARY OF THE SUBJECT MATTER

Interactive and active information executable applications comprise: a) at least one marketing campaign item, b) at least one piece of insight information, c) at least one dynamic consumer profile, d) at least one metric bank, and e) at least one storage medium.

Methods for implementing and utilizing an interactive and active information executable application include: providing at least one marketing campaign item, providing or collecting at least one piece of insight information, providing at least one metric bank, storing the at least one piece of insight information on the at least one metric bank, utilizing or accessing at least one metric bank, developing at least one dynamic consumer profile from the at least one piece of insight information, and accessing at least one computer readable storage medium.

### BRIEF DESCRIPTION OF THE FIGURES

FIG. 1 shows a contemplated method.

FIG. 2 shows a flow chart of a contemplated embodiment.

FIG. 3 shows a flow chart of a contemplated embodiment.

FIG. 4 shows a contemplated embodiment as shown in Example 1.

FIG. 5 shows a contemplated embodiment as shown in Example 1.

FIG. 6 shows a contemplated embodiment as shown in Example 1.

FIG. 7 shows a contemplated embodiment as shown in Example 2.

FIG. 8 shows a contemplated embodiment as shown in Example 2.

FIG. 9 shows a contemplated embodiment as shown in Example 2.

### DETAILED DESCRIPTION

Contemplated systems and embodiments, as disclosed herein, contain, monitor and report on new campaigns for a company's products and/or services in a number of different ways. The first embodiment allows all of the decision makers together to engage in the process of review, approval and monitoring, so that they can make an informed decision on the campaign. As used herein, the term “review” means viewing, reading and/or listening to information related to one or more campaigns, including campaign development, brief writing, review and approval, interactive mark-up or revisions with or without comments, and the like. The second embodiment allows options for the campaign to be reviewed, approved and stored so that they can be rolled out on the fly as information is received during the campaign roll out. The third embodiment tracks useful metrics related to the campaign and its impact. Finally, the marketing team and the company are able to make sense of the metrics in real time to determine if the campaign is on point or whether other marketing options should be presented.

To meet the goals and needs described earlier, systems and embodiments have been developed that allow marketing teams to push out proposed campaign content to key decision makers for review, approval and comment, display the current campaign in all of its forms, capture and present interactive real time marketing data for a company, and at the same time allow the marketing professionals and marketing field teams access to the same information in order to track dynamic consumer interaction with the campaign, product or service. Contemplated systems and services can build a typical consumer profile that is in real time and dynamic. Contemplated embodiments can also access all of this information through the use of an executable mobile application or app.

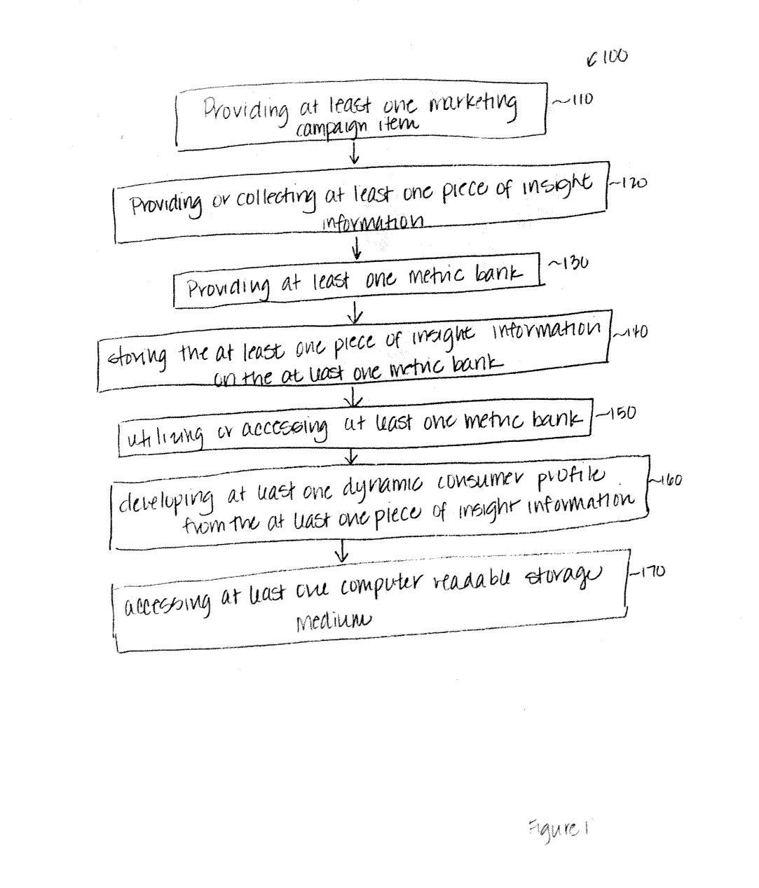

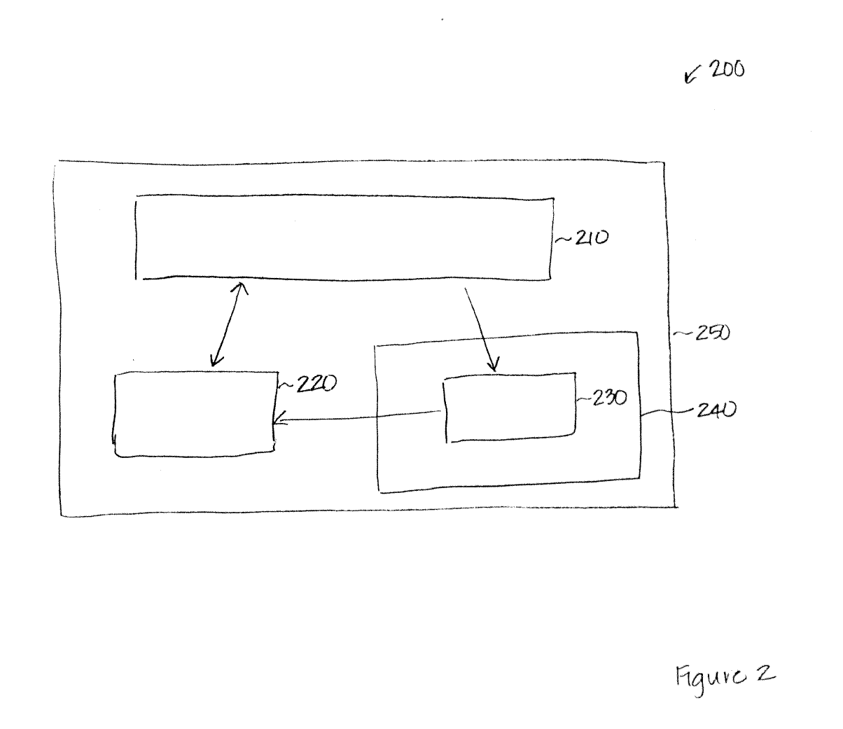

Specifically and as shown in FIG. 2, interactive and active information executable applications 200 comprise: a) at least one marketing campaign item 210, b) at least one piece of insight information 230, c) at least one dynamic consumer profile 220, d) at least one metric bank 240, and e) at least one storage medium 250. Methods 100 for implementing and utilizing an interactive and active information executable application are shown in FIG. 1 and include: providing at least one marketing campaign item 110, providing or collecting at least one piece of insight information 120, providing at least one metric bank 130, storing the at least one piece of insight information on the at least one metric bank 140, utilizing or accessing at least one metric bank 150, developing at least one dynamic consumer profile from the at least one piece of insight information 160, and accessing at least one computer readable storage medium 170.

Contemplated embodiments are can be executed on any suitable device, including a desktop computer, a laptop computer, a tablet device, a handheld device, a “wearable” device, such as Google goggles, or a combination thereof. In some embodiments, an interactive and active information executable application is executable and/or executed on a mobile device.

As mentioned, contemplated embodiments comprise at least the following: a) at least one marketing campaign item, b) at least one piece of insight information, c) at least one dynamic consumer profile, d) at least one metric bank, and e) at least one accessible storage medium. As contemplated, the at least one marketing campaign item comprises any suitable proposed or approved marketing item or collection of marketing items depending on the needs of the company or entity. Contemplated marketing campaign items include artwork, video, audio, text or a combination thereof. Once the application is executed on or from the at least one storage medium, the user will see an introduction screen on the device. One of the options for the user will be to view the at least one marketing campaign item. Once the user selects this option, a menu of proposed items and approved items, for example, will appear on the screen. The user can then go into the application and view any of these items, along with comments (in text, audio or video form, including video files and streaming video) from other designated personnel, including the creative team. The user can provide input in any suitable form to any or all of the marketing items.

Contemplated embodiments also comprise at least one piece of insight information. As disclosed herein, insight information comprises any suitable and useful piece of information about the at least one marketing item and its impact on those who review or interact with the at least one marketing item. Contemplated insight information may comprise information from the designated personnel at the company, including their review notes, their approval notes, their initial impressions or a combination thereof. Contemplated insight information also may comprise information from the general consuming public who views and/or interacts with the at least one marketing campaign item. Insight information may include: a) the number of likes or views on a social media application, b) the number of shares or comments on a social media application, c) the volume or number of products and/or services sold since the at least one marketing item was publically rolled out, d) the number of click throughs on a banner ad, e) the number of online purchases, f) consumer or potential consumer videos or audio content, g) consumer demographic information, h) regional preference information, i) product or service preference information based on demographic information or gender, j) product or service preference information based on annual income, k) sales and consumption data, l) searchable databases of consumer data and/or campaign data, m) source data for campaign development, such as creative briefs and other inspiration for the start of campaign development, n) source material, o) packaging development, creative and review, p) messaging/communication amongst team members regarding content, q) iterative development of materials, r) ongoing discussion and review between teams, s) any other suitable information, and t) combinations thereof.

Contemplated insight information can be automatically or manually reviewed and tagged, sorted or otherwise marked, so that it can be processed and then stored in the at least one metric bank. The at least one metric bank is designed to store all of the insight information, along with tags and additional information as needed in order to develop meaningful output for the marketing/creative team and the company, individual or entity.

The information stored in the at least one metric bank can be accessed, processed and/or utilized in any suitable way, including using this information to produce and/or update at least one dynamic consumer profile. The term “dynamic” means that the consumer profile is not necessarily fixed, but is continually, and in many instances in real time, updated based on the collected information. A contemplated consumer profile may be of a targeted individual or of a targeted group of individuals. Contemplated at least one storage medium may include any suitable computer readable storage medium excluding signals, which can store data that is accessible by a computer, including flash memory cards, digital video disks, Bernoulli cartridges, random access memories (RAMs), read only memories (ROMs), a computer network, the Cloud or a similar network structure, a single computer hard drive, an intranet, the internet or a web design, a storage medium on the accessing device, or a combination thereof.

### EXAMPLES

### Example 1

### Mobile-Optimized Web Application—Option 1

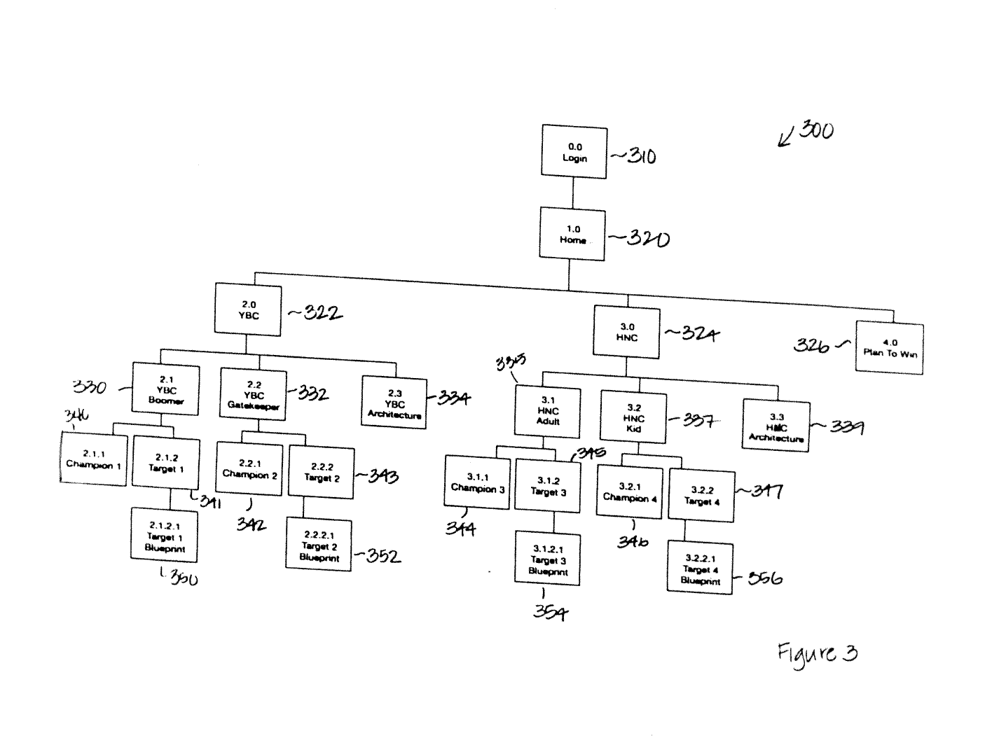

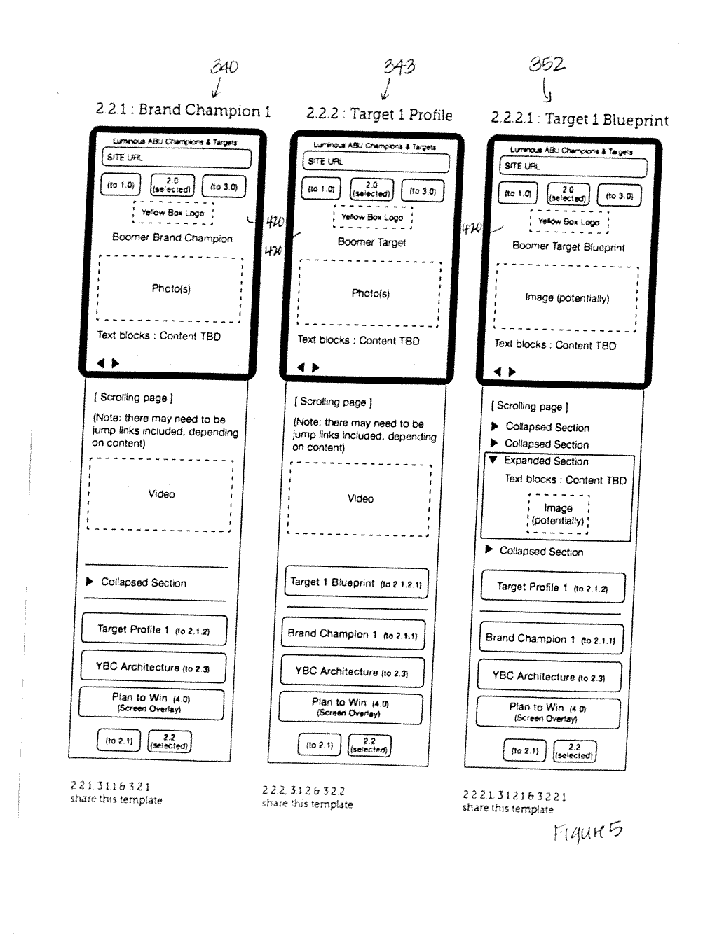

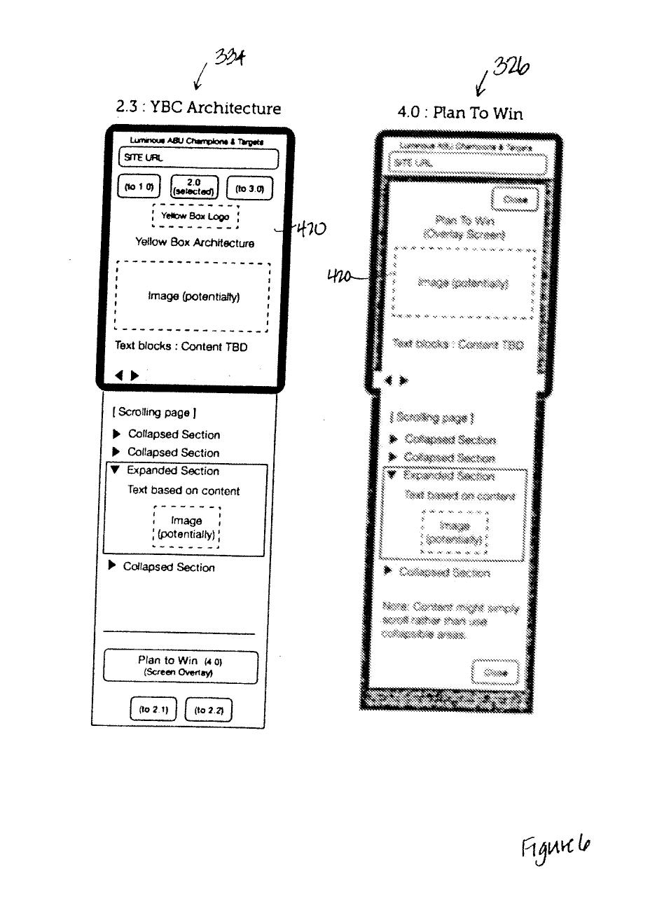

In this example, a launch screen on a device, such as a smart phone, handheld or tablet device, is shown that provides a campaign identifier, along with a user name and password prompt. Once the user provides the proper information, whether by typing in information, speaking information to an audio sensor or providing a biological identifier, such as a fingerprint, the user is taken to a home screen. The home screen shows at least one campaign logo for the user to select. Once the user selects the individual campaign, a number of information screens are provided wherein the user can select and view real-time consumer and marketing information, such as the “brand champion” or the consumer “target profile”. If the user selects the “target profile”, a number of pieces of information can be provided, including photos, videos, demographics, purchase information or a combination thereof, as shown in FIGS. 3 and 4-6. There can be a scrolling page element on the page as well that allows the user to scroll down to more information than can be currently displayed on the device screen.

FIG. 3 shows a site map architecture 300 that is used in both Option 1 and Option 2, along with other options, as should be clear. The Login 310 maps the user to the Home page 320. At the Home page 320, the user (not shown) has the option of choosing one of two campaigns, in this site map, Yellow Box Campaign (YBC) 322 or Honey Nut Cheerios (HNC) Campaign 324. At this level, the user can also select the Plan to Win 326 which pulls all of the information for the campaigns together and presents strategies and metrics for the user.

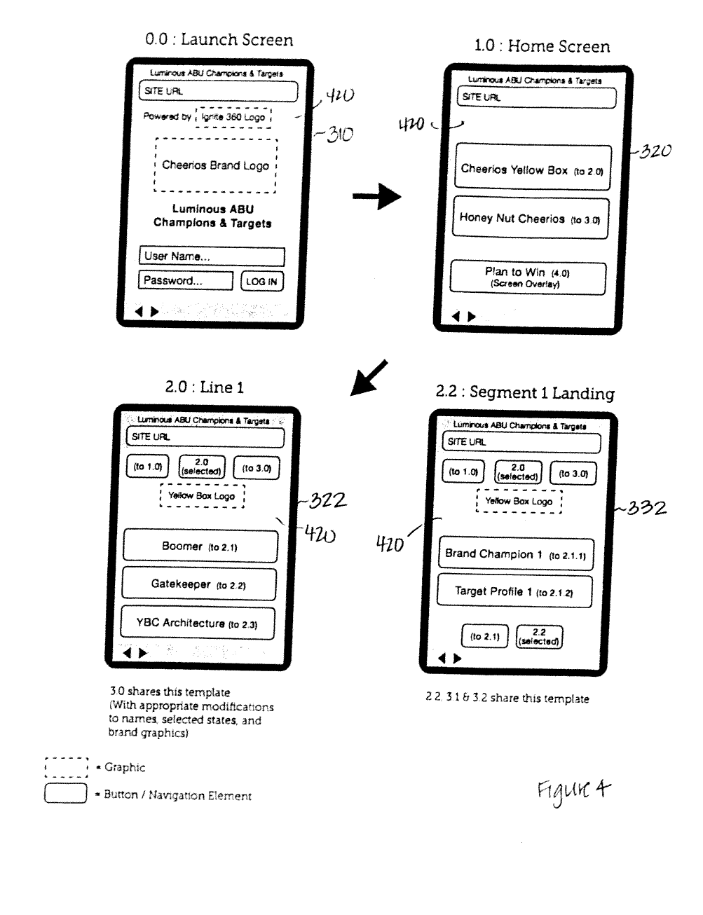

Under each campaign, there are a series of choices that identify different groups of consumers, for example. Under the YBC campaign, there is YBC Boomer 330 and YBC Gatekeeper 332. There is also a YBC Architecture 334 page at this level, so that the user can set up the underlying structure/architecture. At the next level, each group of consumers is broken down into brand targets 341, 343 and brand champions 340, 342. Finally, there's resulting target blueprints 350, 352 under each brand target. Under the HNC campaign, there is HNC Adult 335 and HNC Kid 337. There is also a HNC Architecture 339 page at this level, so that the user can set up the underlying structure/architecture. At the next level, each group of consumers is broken down into brand targets 345, 347 and brand champions 344, 346. Finally, there's resulting target blueprints 354, 356 under each brand target. The screen shots on a device 420 for each of these points on the site map architecture are shown in FIGS. 4-6.

### Example 2

### Mobile-Optimized Web Application—Option 2

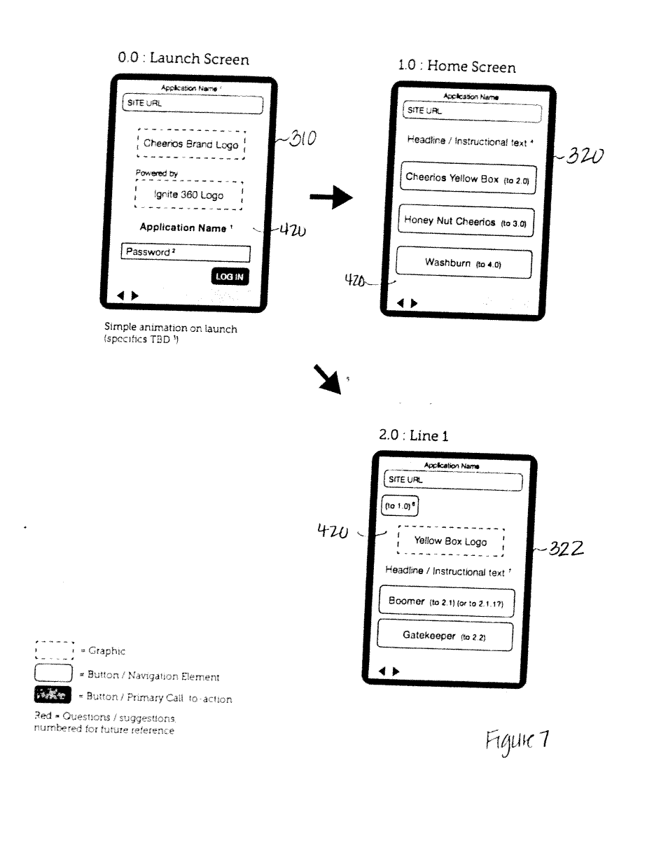

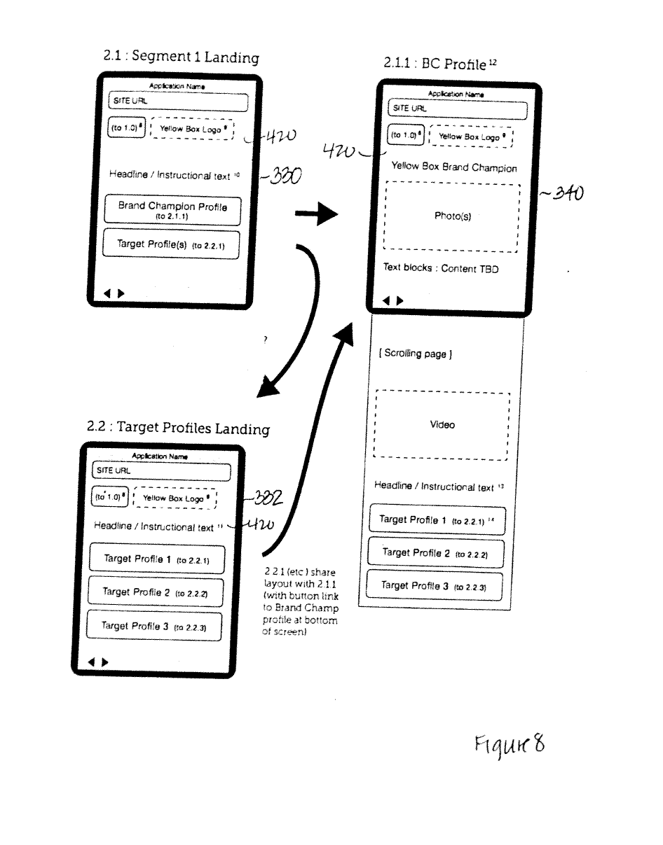

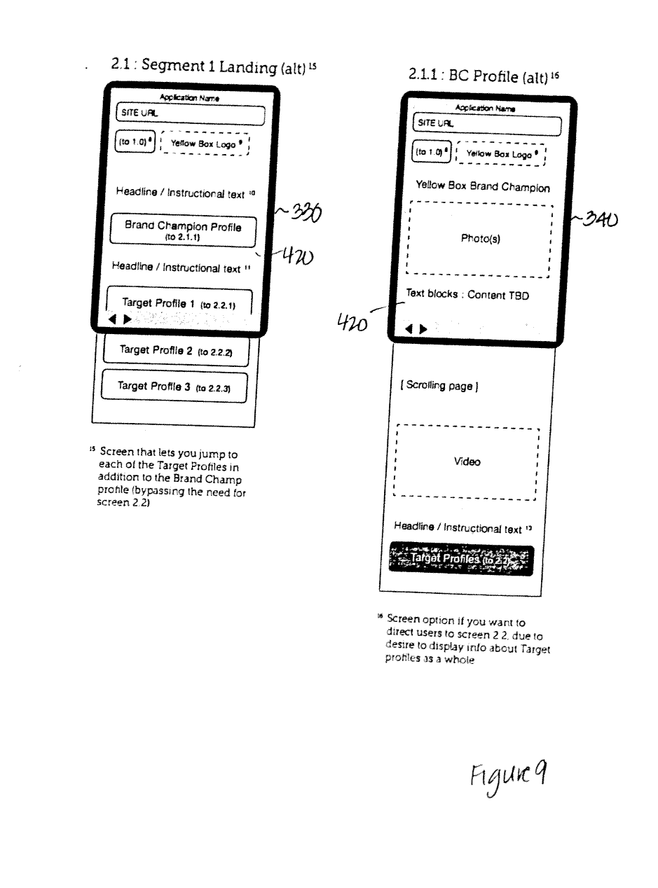

In this example, a launch screen on a device, such as a smart phone, hand-held or tablet device, is shown that provides a campaign identifier, along with a password prompt. Once the user provides the proper information, the user is taken to a home screen. The home screen shows at least one campaign logo for the user to select. Once the user selects the individual campaign, a number of information screens are provided wherein the user can select and view real-time consumer and marketing information, such as the “brand champion” or at least one of the consumer “target profile”, such as Target Profile 1, Target Profile 2 or Target Profile 3. If the user selects one of the “target profiles”, a number of pieces of information can be provided, including photos, videos, demographics, purchase information or a combination thereof, as shown in FIGS. 3 and 7-9. The screen shots on a device 420 for each of these points on the site map architecture are shown in FIGS. 7-9.

Thus, specific embodiments of interactive, real-time marketing systems, their methods of production and use have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification and claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. An interactive and active information executable application, comprising:
at least one marketing campaign item,
at least one piece of insight information,
at least one dynamic consumer profile,
at least one metric bank, and
at least one storage medium.

2. The interactive and active information executable application of claim 1, wherein the application is executed on at least one computer device.

3. The interactive and active information executable application of claim 1, wherein the at least one computer device comprises a hand-held device, a laptop, a desktop computer or a combination thereof.

4. The interactive and active information executable application of claim 1, wherein the hand-held device comprises a tablet computer, a smart phone, computer glasses or a combination thereof.

5. The interactive and active information executable application of claim 1, wherein the at least one marketing campaign item comprises artwork, video, audio, text or a combination thereof.

6. The interactive and active information executable application of claim 1, wherein the at least one marketing campaign item comprises artwork, video, audio, text or a combination thereof.

7. The interactive and active information executable application of claim 1, wherein the at least one metric bank comprises the insight information, at least one tag, at least one piece of additional information or a combination thereof.

8. The interactive and active information executable application of claim 1, wherein the at least one piece of insight information comprises the number of likes or views on a social media application, the number of shares or comments on a social media application, the volume or number of products and/or services sold since the at least one marketing item was publically rolled out, the number of click throughs on a banner ad, the number of online purchases, consumer or potential consumer videos or audio content, consumer demographic information, regional preference information, product or service preference information based on demographic information or gender, product or service preference information based on annual income, sales and consumption data, searchable databases of consumer data and/or campaign data, source data for campaign development, such as creative briefs and other inspiration for the start of campaign development, source material, packaging development, creative and review, messaging/communication amongst team members regarding content, iterative development of materials, ongoing discussion and review between teams, any other suitable information, or a combination thereof.

9. A method for implementing and utilizing an interactive and active information executable application, comprising:
providing at least one marketing campaign item,
providing or collecting at least one piece of insight information,
providing at least one metric bank,
storing the at least one piece of insight information on the at least one metric bank,
utilizing or accessing at least one metric bank,
developing at least one dynamic consumer profile from the at least one piece of insight information, and
accessing at least one computer readable storage medium.

10. The method of claim 9, wherein the application is executed on at least one computer device.

11. The method of claim 9, wherein the at least one computer device comprises a hand-held device, a laptop, a desktop computer or a combination thereof.

12. The method of claim 9, wherein the hand-held device comprises a tablet computer, a smart phone, computer glasses or a combination thereof.

13. The method of claim 9, wherein the at least one marketing campaign item comprises artwork, video, audio, text or a combination thereof.

14. The method of claim 9, wherein the at least one marketing campaign item comprises artwork, video, audio, text or a combination thereof.

15. The method of claim 9, wherein the at least one metric bank comprises the insight information, at least one tag, at least one piece of additional information or a combination thereof.

16. The method of claim 9, wherein the at least one piece of insight information comprises the number of likes or views on a social media application, the number of shares or comments on a social media application, the volume or number of products and/or services sold since the at least one marketing item was publically rolled out, the number of click throughs on a banner ad, the number of online purchases, consumer or potential consumer videos or audio content, consumer demographic information, regional preference information, product or service preference information based on demographic information or gender, product or service preference information based on annual income, sales and consumption data, searchable databases of consumer data and/or campaign data, source data for campaign development, such as creative briefs and other inspiration for the start of campaign development, source material, packaging development, creative and review, messaging/communication amongst team members regarding content, iterative development of materials, ongoing discussion and review between teams, any other suitable information, or a combination thereof.
